(19) United States
(12) Patent Application Publication
(10) Pub. No.: US 2017/0228671 A1
(43) Pub. Date: Aug. 10, 2017

(54) METHOD, APPARATUS, AND SYSTEM FOR GENERATING BUSINESS MODEL, AND COMPUTER READABLE STORAGE MEDIUM

(71) Applicant: Shenzhen Development Promotion Centre for Enterprises, Shenzhen Guangdong (CN)

(72) Inventors: Wei WEI, SHENZHEN GUANGDONG (CN); Wuxiang ZHU, SHENZHEN GUANGDONG (CN)

(73) Assignee: Shenzhen Development Promotion Centre for Enterprises, Shenzhen Guangdong (CN)

(21) Appl. No.: 15/018,255

(22) Filed: Feb. 8, 2016

(51) Int. Cl. G06Q 10/06

(52) U.S. Cl. CPC G06Q 10/067

(57) ABSTRACT

A method, an apparatus, and a system for generating a business model, and a computer readable storage medium are disclosed. The method includes: obtaining information of a target activity link according to platform enterprise information; receiving input standard information and output standard information that are configured by a user according to the information of the target activity link and corresponding to the information of the target activity link; obtaining information of a cooperative enterprise that executes a processing task of the target activity link and is configured by the user according to the information of the target activity link, the input standard information, and the output standard information and corresponding to the information of the target activity link; and generating a new business model according to the platform enterprise information, the information of the target activity link, the input standard information, the output standard information, and the information of the cooperative enterprise. In the business model generated according to an embodiment of the present invention, the platform enterprise effectively controls output quality of each activity link by providing input and output standards of the corresponding activity link for the cooperative enterprise, and therefore can effectively control quality of products or services, transfer the processing task of the activity link to the cooperative enterprise, and avoid a problem of high asset input and low efficiency.

### TECHNICAL FIELD

The present invention relates to the data analysis processing field, and in particular, to a method, an apparatus, and a system for generating a business model, and a computer readable storage medium.

### BACKGROUND

As people's material standard of living is improved, people have higher requirements on quality of products or services that are purchased or used. To meet the requirements of people, many enterprises attach greater importance to the quality of products or services, and strive to provide high-quality products or services for customers.

A series of continuous activities that must be completed in the design, production, and sale of products or sendees is referred to as an industry value chain. Each activity is an activity link, and any activity link involves input, processing, and output.

Currently, an enterprise generally implements effective control over quality of products or services by controlling input standards of various activity links in the industry value chain and executing processing tasks of the activity links by itself However, in this manner, because the enterprise executes the processing tasks by itself, there is always a problem of high asset input and low efficiency.

Currently, there is also a solution to the problem of high asset input and low efficiency, for example, outsourcing, that is, the enterprise entrusts the processing tasks of some activity links in the industry value chain to a partner for implementation, and the partner is responsible for the input and processing of the activity links, while the enterprise itself only controls output standards of the activity links. However, in this manner, because the enterprise itself does not participate in and control the input and processing of each activity link, its control over output of each link is reduced intangibly, and there is still a problem that the quality of products or sendees cannot be controlled effectively.

### SUMMARY

Objectives of the present invention are to provide a method, an apparatus, and a system for generating a business model, and a computer readable storage medium.

A method for generating a business model is disclosed, where the method includes the following steps:

obtaining information of a target activity link according to platform enterprise information;

receiving input standard information and output standard information that are configured by a user according to the information of the target activity link and corresponding to the information of the target activity link;

obtaining information of a cooperative enterprise that executes a processing task of the target activity link and is configured by the user according to the information of the target activity link, the input standard information, and the output standard information and corresponding to the information of the target activity link; and

generating a new business model according to the platform enterprise information, the information of the target activity link, the input standard information, the output standard information, and the information of the cooperative enterprise; where

a structure of the new business model includes a platform enterprise and at least one cooperative enterprise that has a relationship with the platform enterprise based on input, processing, and output of an activity link, where the platform enterprise provides input and output standards of the activity link for the cooperative enterprise, and the cooperative enterprise executes a processing task of the activity link.

An apparatus for generating a business model is disclosed, where the apparatus includes:

a target activity link information obtaining unit, configured to obtain information of a target activity link according to platform enterprise information;

a standard information receiving unit, configured to receive input standard information and output standard information that are configured by a user according to the information of the target activity link and corresponding to the information of the target activity link;

a cooperative enterprise information obtaining unit, configured to obtain information of a cooperative enterprise that executes a processing task of the target activity link and is configured by the user according to the information of the target activity link, the input standard information, and the output standard information and corresponding to the information of the target activity link; and

a business model generation unit, configured to generate a new business model according to the platform enterprise information, the information of the target activity link, the input standard information, the output standard information, and the information of the cooperative enterprise; where

a structure of the new business model includes a platform enterprise and at least one cooperative enterprise that has a relationship with the platform enterprise based on input, processing, and output of an activity link, where the platform enterprise provides input and output standards of the activity link for the cooperative enterprise, and the cooperative enterprise executes a processing task of the activity link.

A system for generating a business model is disclosed, where the system includes:

a bus, configured to transmit signaling and data;

a user interface adapter, configured to connect an input device to the bus, receive input standard information and output standard information that are configured by a user according to information of a target activity link and corresponding to the information of the target activity link, and receive information of a cooperative enterprise that executes a processing task of the target activity link and is configured by the user according to the information of the target activity link, the input standard information, and the output standard information and corresponding to the information of the target activity link;

a display adapter, configured to connect a display device to the bus, display an interface for inputting the information of the target activity link, the input standard information, the output standard information, and the information of the cooperative enterprise, and display a generated new business model; and

a business model generation apparatus, configured to obtain the information of the target activity link according to platform enterprise information, and generate a new business model according to the platform enterprise information, the information of the target activity link, the input standard information, the output standard information, and the information of the cooperative enterprise; where

a structure of the new business model includes a platform enterprise and at least one cooperative enterprise that has a relationship with the platform enterprise based on input, processing, and output of an activity link, where the platform enterprise provides input and output standards of the activity link for the cooperative enterprise, and the cooperative enterprise executes a processing task of the activity link.

A computer readable storage medium is disclosed, where the computer readable storage medium stores a computer program instruction executable by a computer, and when the computer executes the computer program instruction, the computer executes a method for generating a business model, where the method for generating a business model includes:

obtaining information of a target activity link according to platform enterprise information;

receiving input standard information and output standard information that are configured by a user according to the information of the target activity link and corresponding to the information of the target activity link;

obtaining information of a cooperative enterprise that executes a processing task of the target activity link and is configured by the user according to the information of the target activity link, the input standard information, and the output standard information and corresponding to the information of the target activity link; and

generating a new business model according to the platform enterprise information, the information of the target activity link, the input standard information, the output standard information, and the information of the cooperative enterprise; where

a structure of the new business model includes a platform enterprise and at least one cooperative enterprise that has a relationship with the platform enterprise based on input, processing, and output of an activity link, where the platform enterprise provides input and output standards of the activity link for the cooperative enterprise, and the cooperative enterprise executes a processing task of the activity link.

In the method for generating a business model according to the present invention, information of a target activity link is obtained according to platform enterprise information; further, input standard information and output standard information that are configured by a user according to the information of the target activity link and corresponding to the information of the target activity link are received; information of a cooperative enterprise that executes a processing task of the target activity link and is configured according to the information of the target activity link, the input standard information, and the output standard information and corresponding to the information of the target activity link is received; and a new business model is generated according to the platform enterprise information, the information of the target activity link, the input standard information, the output standard information, and the information of the cooperative enterprise. In the generated new business model, a platform enterprise effectively controls output quality of each activity link by providing input and output standards of the corresponding activity link for the cooperative enterprise, and therefore can effectively control quality of products or services, transfer the processing task of the activity link to the cooperative enterprise, and avoid a problem of high asset input and low efficiency. In the business model, by means of specialized management on entities and integrated operation on virtual control, the platform enterprise can implement better control and can leverage more resources with less input, although the platform enterprise seemingly does fewer things.

### BRIEF DESCRIPTION OF DRAWINGS

FIG. 1 is a flowchart of a specific implementation manner of a method for generating a business model according to the present invention;

FIG. 2 is a schematic block diagram of a specific implementation manner of a structure of a business model according to the present invention;

FIG. 3 is a schematic block diagram of a specific implementation manner of an apparatus for generating a business model according to the present invention; and

FIG. 4 is a schematic block diagram of a specific implementation manner of a system for generating a business model according to the present invention.

### DESCRIPTION OF THE EMBODIMENTS

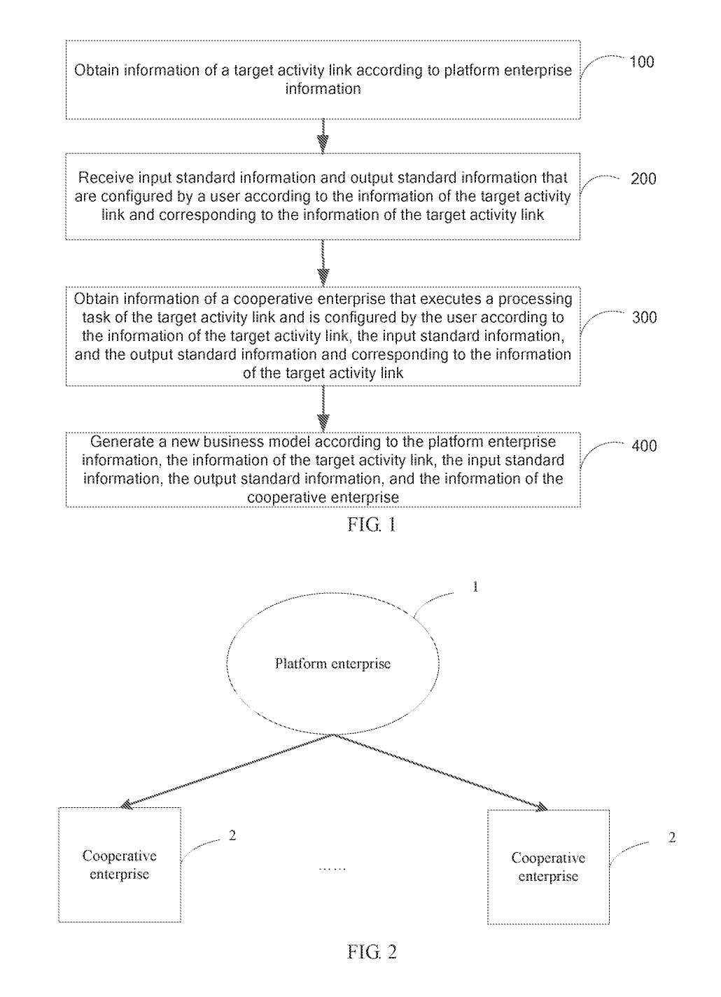

FIG. 1 shows a specific implementation manner of a method for generating a business model according to the present invention. The method includes;

Step 100: Obtain information of a target activity link according to platform enterprise information.

In the present invention, obtained target activity link information may be information of one or more target activity links. When the activity link information is information of two or more than two activity links, the activity links are independent of each other. That the activity links are independent of each other, on the one hand, ensures smooth interconnection of the activity links, and on the other hand, may ensure that each activity link can grow larger, stronger, and more specialized.

An industry value chain is a series of continuous activities that must be completed in the design, production, and sale of products or services. Each activity is an activity link, and any activity link involves input, processing, and output, where resources are input, processing reflects a capacity of a stakeholder, and ownership of output defines a role of the stakeholder.

In the present invention, the target activity link is an activity link that is related to a platform enterprise and of which a business model can be improved, in an industry value chain of the platform enterprise.

In the present invention, the information of the target activity link may be obtained by directly receiving activity link information entered by a user or by analyzing the industry value chain.

Step 200: Receive input standard information and output standard information that are configured by a user according to the information of the target activity link and corresponding to the information of the target activity link.

An input standard defines a condition that a resource input in each activity link should meet, and an output standard defines a condition that a product or service output in each activity link should meet. The input standard and the output standard can effectively control quality of products or services in each activity link.

For example, company A is a platform enterprise 1, and company B is a cooperative enterprise 2, where company A is an air-conditioner manufacturer; company A has a relationship with company B based on an activity link of compressor production; company A provides an input standard, for example, a supplier of components for producing compressors, and models of compressors, and an output standard, for example, performance specifications of manufactured compressors, for company B.

In the present invention, the platform enterprise 1 may provide the input standard of the activity link for the cooperative enterprise 2 by designating an upstream supplier for the cooperative enterprise 2.

In the present invention, to ensure quality and controllability of key components, for some manufacturing activity links, the platform enterprise 1 controls the input standard of the cooperative enterprise 2 by directly providing a key component production device for the cooperative enterprise 2, and thereby controls the output of the activity link, so that the output complies with the output standard of the activity link.

In the present invention, the input standard may be an upstream supplier designated by the platform enterprise for the cooperative enterprise, or a key component production device provided by the platform enterprise for the cooperative enterprise.

Step 300: Receive information of a cooperative enterprise that executes a processing task of the target activity link and is configured by the user according to the information of the target activity link, the input standard information, and the output standard information and corresponding to the information of the target activity link.

Step 400: Generate a new business model according to the platform enterprise information, the information of the target activity link, the input standard information, the output standard information, and the information of the cooperative enterprise.

FIG. 2 shows a structure of the new business model obtained by using the foregoing method. The structure of the business model includes a platform enterprise 1 and at least one cooperative enterprise 2 that has a relationship with the platform enterprise 1 based on input, processing, and output of an activity link, where the platform enterprise 1 provides input and output standards of the activity link for the cooperative enterprise 2, and the cooperative enterprise 2 executes a processing task of the activity link.

For example, company A is a platform enterprise 1, and company B is a cooperative enterprise 2, where company A is an air-conditioner manufacturer; company A has a relationship with company B based on an activity link of compressor production; company A provides an input standard and an output standard for company B, for example, a supplier of components for producing compressors, and models of compressors, and performance specifications of manufactured compressors.

In the present invention, obtained target activity link information may be information of one or more target activity links. When the activity link information is information of two or more than two activity links, the activity links are independent of each other. That the activity links are independent of each other, on the one hand, ensures smooth interconnection of the activity links, and on the other hand, may ensure that each activity link can grow larger, stronger, and more specialized.

In the present invention, one target activity link may correspond to one or more cooperative enterprises 2. When one target activity link corresponds to multiple cooperative enterprises 2, a compatibility problem becomes more obvious. Therefore, in the present invention, when one activity link corresponds to multiple cooperative enterprises 2, a transaction interface between the platform enterprise 1 and each cooperative enterprise 2 is standardized.

In the present invention, transaction interface standardization means that a transaction mode, a transaction rule, and the like between the platform enterprise 1 and each cooperative enterprise 2 may be copied, and do not need to be customized.

Because the business model may involve multiple activity links, and due to the flow of resources between different enterprises in multiple different areas, in the present invention, the platform enterprise 1 is capable of supply chain management and logistics consolidation.

In the method for generating a business model according to the present invention, information of a target activity link is obtained according to platform enterprise information; further, input standard information and output standard information that are configured by a user according to the information of the target activity link and corresponding to the information of the target activity link are received; information of a cooperative enterprise that executes a processing task of the target activity link and is configured according to the information of the target activity link, the input standard information, and the output standard information and corresponding to the information of the target activity link is received; and a new business model is generated according to the platform enterprise information, the information of the target activity link, the input standard information, the output standard information, and the information of the cooperative enterprise. In the generated new business model, a platform enterprise effectively controls output quality of each activity link by providing input and output standards of the corresponding activity link for the cooperative enterprise, and therefore can effectively control quality of products or services, transfer the processing task of the activity link to the cooperative enterprise, and avoid a problem of high asset input and low efficiency. In the business model, by means of specialized management on entities and integrated operation on virtual control, the platform enterprise can implement better control and can leverage more resources with less input, although the platform enterprise seemingly does fewer things.

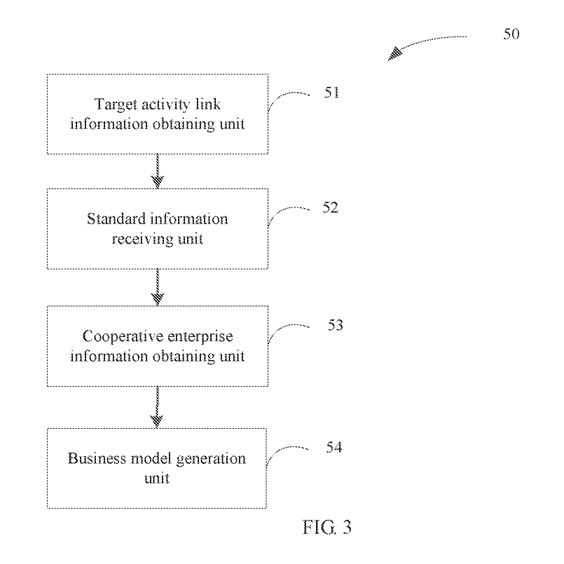

FIG. 3 shows a specific implementation manner of an apparatus for generating a business model according to the present invention. The apparatus 50 includes a target activity link information obtaining unit 51, a standard information receiving unit 52, a cooperative enterprise information obtaining unit 53, and a business model generation unit 54.

The target activity link information obtaining unit 51 is configured to obtain information of a target activity link according to platform enterprise information.

In the present invention, obtained target activity link information may be information of one or more target activity links. When the activity link information is information of two or more than two activity links, the activity links are independent of each other. That the activity links are independent of each other, on the one hand, ensures smooth interconnection of the activity links, and on the other hand, may ensure that each activity link can grow larger, stronger, and more specialized.

An industry value chain is a series of continuous activities that must be completed in the design, production, and sale of products or services. Each activity is an activity link, and any activity link involves input, processing, and output, where resources are input, processing reflects a capacity of a stakeholder, and ownership of output defines a role of the stakeholder.

In the present invention, the target activity link is an activity link that is related to a platform enterprise and of which a business model can be improved, in an industry value chain of the platform enterprise.

In the present invention, the information of the target activity link may be obtained by directly receiving activity link information entered by a user or by analyzing the industry value chain.

The standard information receiving unit 52 is configured to receive input standard information and output standard information that are configured by a user according to the information of the target activity link and corresponding to the information of the target activity link.

An input standard defines a condition that a resource input in each activity link should meet, and an output standard defines a condition that a product or service output in each activity link should meet. The input standard and the output standard can effectively control quality of products or services in each activity link.

For example, company A is a platform enterprise 1, and company B is a cooperative enterprise 2, where company A is an air-conditioner manufacturer; company A has a relationship with company B based on an activity link of compressor production; company A provides an input standard, for example, a supplier of components for producing compressors, and models of compressors, and an output standard, for example, performance specifications of manufactured compressors, for company B.

In the present invention, the platform enterprise 1 may provide the input standard of the activity link for the cooperative enterprise 2 by designating an upstream supplier for the cooperative enterprise 2.

In the present invention, to ensure quality and controllability of key components, for some manufacturing activity links, the platform enterprise 1 controls the input standard of the cooperative enterprise 2 by directly providing a key component production device for the cooperative enterprise 2, and thereby controls the output of the activity link, so that the output complies with the output standard of the activity link.

In the present invention, the input standard may be an upstream supplier designated by the platform enterprise for the cooperative enterprise, or a key component production device provided by the platform enterprise for the cooperative enterprise.

The cooperative enterprise information obtaining unit 53 is configured to obtain information of a cooperative enterprise that executes a processing task of the target activity link and is configured by the user according to the information of the target activity link, the input standard information, and the output standard information and corresponding to the information of the target activity link.

The business model generation unit 54 is configured to generate a new business model according to the platform enterprise information, the information of the target activity link, the input standard information, the output standard information, and the information of the cooperative enterprise.

A structure of the new business model includes a platform enterprise and at least one cooperative enterprise that has a relationship with the platform enterprise based on input, processing, and output of an activity link, where the platform enterprise provides input and output standards of the activity link for the cooperative enterprise, and the cooperative enterprise executes a processing task of the activity link.

For example, company A is a platform enterprise, and company B is a cooperative enterprise, where company A is an air-conditioner manufacturer; company A has a relationship with company B based on an activity link of compressor production; company A provides an input standard and an output standard for company B, for example, a supplier of components for producing compressors, and models of compressors, and performance specifications of manufactured compressors.

In the present invention, when there are two or more than two activity links, the activity links are independent of each other. That the activity links are independent of each other, on the one hand, ensures smooth interconnection of the activity links, and on the other hand, may ensure that each activity link can grow larger, stronger, and more specialized.

Therefore, in the present invention, when one activity link corresponds to multiple cooperative enterprises, a transaction interface between the platform enterprise and each cooperative enterprise is standardized.

In the present invention, transaction interface standardization means that a transaction mode, a transaction rule, and the like between the platform enterprise and each cooperative enterprise may be copied, and do not need to be customized.

Because the business model may involve multiple activity links, and due to the flow of resources between different enterprises in multiple different areas, in the present invention, the platform enterprise is capable of supply chain management and logistics consolidation.

In the apparatus for generating a business model according to the present invention, information of a target activity link is obtained according to platform enterprise information; further, input standard information and output standard information that are configured by a user according to the information of the target activity link and corresponding to the information of the target activity link are received; information of a cooperative enterprise that executes a processing task of the target activity link and is configured according to the information of the target activity link, the input standard information, and the output standard information and corresponding to the information of the target activity link is received; and a new business model is generated according to the platform enterprise information, the information of the target activity link, the input standard information, the output standard information, and the information of the cooperative enterprise. In the generated new business model, a platform enterprise effectively controls output quality of each activity link by providing input and output standards of the corresponding activity link for the cooperative enterprise, and therefore can effectively control quality of products or services, transfer the processing task of the activity link to the cooperative enterprise, and avoid a problem of high asset input and low efficiency. In the business model, by means of specialized management on entities and integrated operation on virtual control, the platform enterprise can implement better control and can leverage more resources with less input, although the platform enterprise seemingly does fewer things.

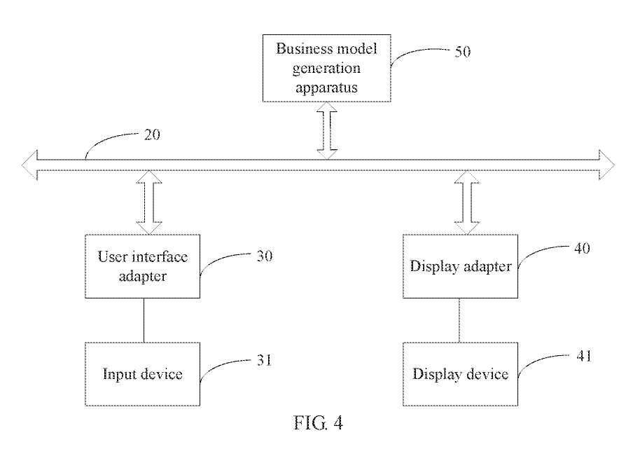

FIG. 4 shows a specific implementation manner of a system for generating a business model. The system includes:

a bus 20, configured to transmit signaling and data;

a user interface adapter 30, configured to connect an input device 31 to the bus 20, receive input standard information and output standard information that are configured by a user according to information of a target activity link and corresponding to the information of the target activity link, and receive information of a cooperative enterprise that executes a processing task of the target activity link and is configured by the user according to the information of the target activity link, the input standard information, and the output standard information and corresponding to the information of the target activity link, where the input device 31 includes but is not limited to a keyboard, a mouse, a speaker, a microphone, or the like;

a display adapter 40, configured to connect a display device 41 to the bus 20, display an interface for inputting the information of the target activity link, the input standard information, the output standard information, and the information of the cooperative enterprise, and display a generated new business model, where the display device 41 may be a display, a printer, or an information generation apparatus; and

a business model generation apparatus 50, as described in the specific implementation manner corresponding to FIG. 3, configured to receive the input standard information and output standard information that are transmitted by the user interface adapter 30 through the bus 20 and corresponding to the information of the target activity link, and the information of the cooperative enterprise that executes the processing task of the activity link and is configured by the user according to the information of the target activity link, the input standard information, and the output standard information and corresponding to the information of the target activity link, obtain the information of the target activity link according to platform enterprise information, generate a new business model according to the platform enterprise information, the information of the target activity link, the input standard information, the output standard information, and the information of the cooperative enterprise, and transmit the new business model to the display adapter 40 through the bus 20.

The business model generation apparatus 50 may be implemented by hardware, or implemented by software, or implemented by a combination of software and hardware.

The apparatus is not described exhaustively herein. For detailed information, reference may be made to the detailed description in the specific implementation manner of the apparatus for generating a business model.

In the system for generating a business model according to the present invention, information of a target activity link is obtained according to platform enterprise information; further, input standard information and output standard information that are configured by a user according to the information of the target activity link and corresponding to the information of the target activity link are received; information of a cooperative enterprise that executes a processing task of the target activity link and is configured according to the information of the target activity link, the input standard information, and the output standard information and corresponding to the information of the target activity link is received; and a new business model is generated according to the platform enterprise information, the information of the target activity link, the input standard information, the output standard information, and the information of the cooperative enterprise. In the generated new business model, a platform enterprise effectively controls output quality of each activity link by providing input and output standards of the corresponding activity link for the cooperative enterprise, and therefore can effectively control quality of products or services, transfer the processing task of the activity link to the cooperative enterprise, and avoid a problem of high asset input and low efficiency. In the business model, by means of specialized management on entities and integrated operation on virtual control, the platform enterprise can implement better control and can leverage more resources with less input, although the platform enterprise seemingly does fewer things.

A person of ordinary skill in the art understands that each aspect of the present invention or a possible implementation manner of each aspect may be specifically implemented as a system, a method, or a computer program product. Therefore, each aspect of the present invention or the possible implementation manner of each aspect may use a form of hardware only embodiments, software only embodiments (including firmware, resident software, and the like), or embodiments with a combination of software and hardware, which are collectively called “a circuit”, “a module”, or “a system”. In addition, each aspect of the present invention or the possible implementation manner of each aspect may use a form of a computer program product, where the computer program product refers to computer readable program code stored in a computer readable medium.

The computer readable medium may be a computer readable signal medium or a computer readable storage medium. A computer readable storage medium includes but is not limited to an electronic, magnetic, optical, electromagnetic, infrared, or semiconductor system, device, or apparatus, or any suitable combination of the foregoing, for example, a random access memory (RAM), a read-only memory (ROM), an erasable programmable read-only memory (EPROM or flash memory), an optical fiber, or a portable compact disc read-only memory (CD-ROM).

A processor in a computer reads the computer readable program code stored in the computer readable medium, so that the processor can execute each step in the flowchart or function actions specified in a combination of steps, and generate an apparatus for implementing each block in a block diagram or function actions specified in a combination of blocks.

The computer readable program code may be completely executed on a computer of a user, or partially executed on a computer of a user, or as an independent software package, partially executed on a computer of a user and partially executed on a remote computer, or completely executed on a remote computer or a server. It should also be noted that in some alternative implementation solutions, each step in the flowchart or the function indicated by each block in the block diagram may occur not in accordance with the sequence indicated in the drawing. For example, two steps or two blocks that are connected and shown depending on involved functions may be actually executed approximately at the same time, or sometimes these blocks may be executed in a reverse sequence.

It is apparent to a person skilled in the art that various modifications and variations can be made to the present invention without departing from the scope or spirit of the present invention. The present invention is intended to cover these modifications and variations provided that they fall within the scope of protection defined by the following claims and their equivalent technologies.

1. A method tor generating a business model, wherein the method comprises the following steps:
obtaining information of a target activity link according to platform enterprise information;
receiving input standard information and output standard information that are configured by a user according to the information of the target activity link and corresponding to the information of the target activity link;
obtaining information of a cooperative enterprise that executes a processing task of the target activity link and is configured by the user according to the information of the target activity link, the input standard information, and the output standard information and corresponding to the information of the target activity link; and
generating a new business model according to the platform, enterprise information, the information of the target activity link, the input standard information, the output standard information, and the information of the cooperative enterprise; wherein
a structure of the new business model comprises a platform enterprise and at least one cooperative enterprise that has a relationship with the platform enterprise based on input, processing, and output of an activity link, wherein the platform enterprise provides input and output standards of the activity link for the cooperative enterprise, and the cooperative enterprise executes a processing task of the activity link.

2. The method for generating a business model according to claim 1, wherein the information of the target activity link is obtained by directly receiving activity link information entered by the user or by analyzing an industry value chain.

3. The method for generating a business model according to claim 1, wherein the input standard is an upstream supplier designated by the platform enterprise for the cooperative enterprise, or a key component production device provided by the platform enterprise for the cooperative enterprise.

4. The method for generating a business model according to claim 1, wherein when there are two or more than two activity links, the activity links are independent of each other.

5. An apparatus for generating a business model, wherein the apparatus comprises:
a target activity link information obtaining unit, configured to obtain information of a target activity link according to platform enterprise information;
a standard information receiving unit, configured to receive input standard information and output standard information that are configured by a user according to the information of the target activity link and corresponding to the information of the target activity link;
a cooperative enterprise information obtaining unit, configured to obtain information of a cooperative enterprise that executes a processing task of the target activity link and is configured by the user according to the information of the target activity link, the input standard information, and the output standard information and corresponding to the information of the target activity link; and
a business model generation unit, configured to generate a new business model according to the platform enterprise information, the information of the target activity link, the input standard information, the output standard information, and the information of the cooperative enterprise; wherein
a structure of the new business model comprises a platform enterprise and at least one cooperative enterprise that has a relationship with the platform enterprise based on input, processing, and output of an activity link, wherein the platform enterprise provides input and output, standards of the activity link for the cooperative enterprise, and the cooperative enterprise executes a processing task of the activity link.

6. The apparatus for generating a business model according to claim 5, wherein the target activity link information obtaining unit obtains the information of the target activity link by directly receiving activity link information entered by the user or by analyzing an industry value chain.

7. The apparatus for generating a business model according to claim 5, wherein the platform enterprise provides the input standard of the activity link for the cooperative enterprise by designating an upstream supplier for the cooperative enterprise or by providing a key component production device for the cooperative enterprise.

8. A system for generating a business model, wherein the system comprises:
a bus, configured to transmit signaling and data;
a user interface adapter, configured to connect an input device to the bus, receive input standard information and output standard information that are configured by a user according to information of a target activity link and corresponding to the information of the target activity link, and receive information of a cooperative enterprise that executes a processing task of the target activity link and is configured by the user according to the information of the target activity link, the input standard information, and the output standard information and corresponding to the information of the target activity link;
a display adapter, configured to connect a display device to the bus, display an interface for inputting the information of the target activity link, the input standard information, the output standard information, and the information of the cooperative enterprise, and display a generated new business model; and
a business model generation apparatus, configured to obtain the information of the target activity link according to platform enterprise information, and generate a new business model according to the platform enterprise information, the information of the target activity link, the input standard information, the output standard information, and the information of the cooperative enterprise; wherein
a structure of the new business model comprises a platform enterprise and at least one cooperative enterprise that has a relationship with the platform enterprise based on input, processing, and output of an activity link, wherein the platform enterprise provides input and output standards of the activity link for the cooperative enterprise, and the cooperative enterprise executes a processing task of the activity link.

9. The system for generating a business model according to claim 8, wherein the input standard is a condition that a resource input in each activity link should meet, and the output standard is a condition that a product or service output in each activity link should meet.

10. A computer readable storage medium, wherein the computer readable storage medium stores a computer program instruction executable by a computer, and when the computer executes the computer program instruction, the computer executes a method for generating a business model, wherein the method for generating a business model comprises:
obtaining information of a target activity link according to platform enterprise information;
receiving input standard information and output standard information that are configured by a user according to the information of the target activity link and corresponding to the information of the target activity link;
obtaining information of a cooperative enterprise that executes a processing task of the target activity link and is configured by the user according to the information of the target activity link, the input standard information, and the output standard information and corresponding to the information of the target activity link; and
generating a new business model according to the platform enterprise information, the information of the target activity link, the input standard information, the output standard information, and the information or the cooperative enterprise; wherein
a structure of the new business model comprises a platform enterprise and at least one cooperative enterprise that has a relationship with the platform enterprise based on input, processing, and output of an activity link, wherein the platform enterprise provides input and output standards of the activity link for the cooperative enterprise, and the cooperative enterprise executes a processing task of the activity link.

11. The computer readable storage medium according to claim 10, wherein the input standard is a condition that a resource input in each activity link should meet, and the output standard is a condition that a product or service output in each activity link should meet.

12. The method for generating a business model according to claim 2, wherein the input standard is an upstream supplier designated by the platform enterprise for the cooperative enterprise, or a key component production device provided by the platform enterprise for the cooperative enterprise.
